(19) United States
(12) Patent Application Publication
(10) Pub. No.: US 2005/0145661 A1
(43) Pub. Date: Jul. 7, 2005

(54) Suspended storage system

(75) Inventor: Patrick Ayoub, Bloomfield Hills, MI (US)

Correspondence Address: LEAR CORPORATION, BLISS MCGLYNN, P.C., 2075 WEST BIG BEAVER ROAD, SUITE 600, TROY, MI, 48084, US

(73) Assignee: Lear Corporation

(21) Appl. No.: 10/751,186

(22) Filed: Jan. 2, 2004

(51) Int. Cl. B60R 9/00; B60R 11/00

(52) U.S. Cl. 224/497

(57) ABSTRACT

A trunk space storage system comprising at least one cross car bar, at least one recess, and at least one storage container. This trunk space storage system further comprises one front right recess, one left front recess, one right back recess, and one left back recess are located on the side walls of the motor vehicle. The front cross car bar fits between front right recess and front left recess. The back cross car bar fits between back right recess and back left recess. The storage container fits between front cross car bar and back cross car bar to create the trunk space storage system. This trunk space storage system is an improved and easy to use system for those who have difficulty accessing trunk space or for those who want to prevent spills of damage to objects held in trunk space.

### FIELD OF INVENTION

This invention relates to the trunk space of a motor vehicle. More specifically, it relates to organization or storage of objects within that trunk space.

### BACKGROUND OF INVENTION

In motor vehicles, the trunk space is the place where drivers and their passengers store personal belongings so that the passenger area of the motor vehicle can be used more comfortably. As a result, there is a high demand for more trunk space in motor vehicles. Many manufacturers have met this demand by making trunk space deeper into the motor vehicle. Many drivers and their passengers have enjoyed this deeper trunk space with no problems. However, some drivers and/or passengers are either elderly or have certain physical disabilities that make it difficult for them to bend that far over to reach into the now deeper trunk space. Even if those users do not specifically place an object within the deep trunk space, there is still a chance that the object will roll back into that space during travel thereby making it extremely difficult for the user to retrieve the object from the back of the deep trunk space. As a result, there has been a demand to help solve this problem.

Another problem with large trunk spaces is that objects placed in the trunk have a tendency to roll around in the trunk space as the user is driving. This can lead to damage to objects or even spills in the trunk space. Consumers have long desired a way to control objects placed in the trunk space so as to avoid damage or unnecessary spills.

In prior art, there are many cargo management systems available. However, many of these solutions to consumer demand involve a more permanent fixtures in a motor vehicle and are costly to install/remove. Additionally, many of these systems are quite bulky and may be difficult to move for some users. Some consumers simply want an easy, lightweight system for cargo management.

This invention solves the above-mentioned problems in a very use to use, low cost way. This invention allows for easy installation/removal of the system by the user. It provides trunk space storage at a convenient height so that users who may have physical impairments can easily access objects in the trunk without having to bend over to far. Additionally, the storage containers are lightweight and removable for use outside of the car if the user desires.

### SUMMARY OF THE INVENTION

The object of this invention relates to an improved trunk space storage system. This trunk space storage system comprises at least one cross car bar, at least one recess, and at least one storage container. This trunk space storage system further comprises one front cross car bar, one back cross car bar, one front right recess, one left front recess, one right back recess, and one left back recess.

The recesses are to be located on the side walls of the trunk space. The front cross car bar fits between the one front right recess and the one front left recess. The back cross car bar fits between the one back right recess and one back left recess. At least one storage container fits over the front cross car bar and back cross car bar. The storage container is removable for easy transport outside of the motor vehicle.

Other features and advantages of this invention will become apparent from the following drawings and the detailed description of the preferred embodiment.

### DETAILED DESCRIPTION OF THE DRAWINGS

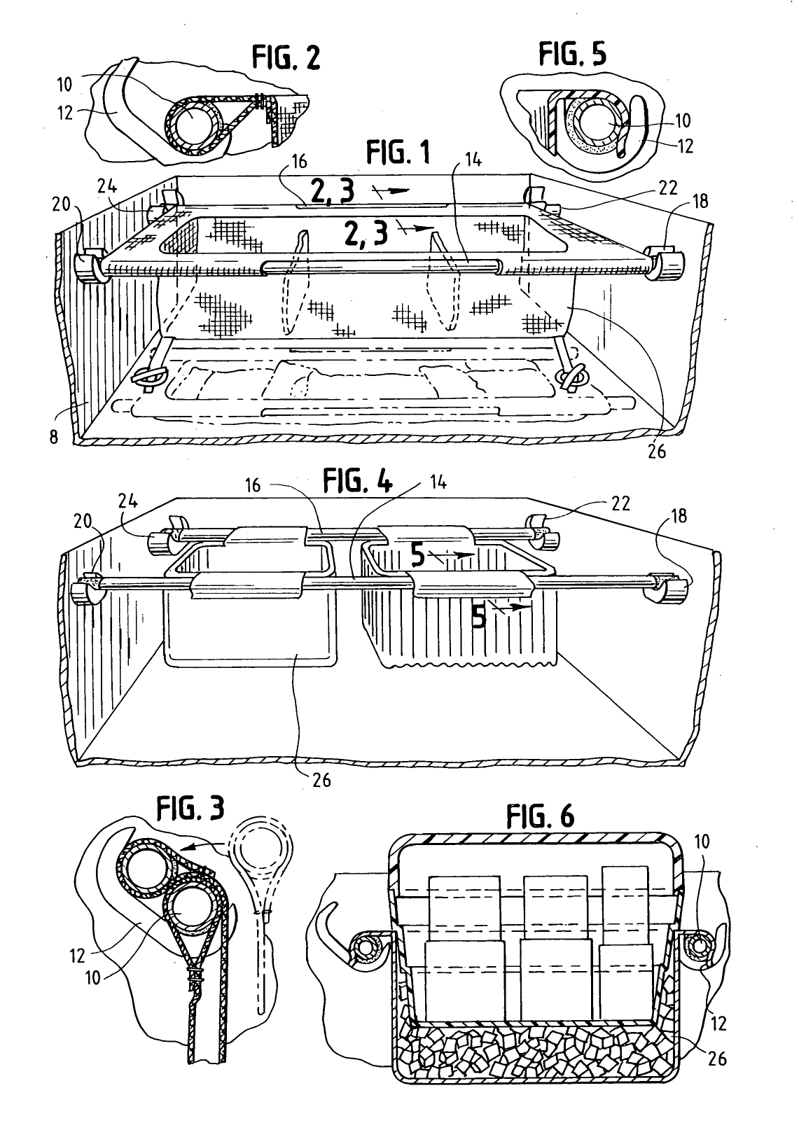

FIG. 1 is a view of the trunk space storage system in the motor vehicle depicting the storage container in use and folded on the trunk space floor.

FIG. 2 is a cross-sectional view of a cross car bar in the recess.

FIG. 3 is a view of the two cross car bars in a recess depicting a stowed position.

FIG. 4 is a view of the trunk space storage system in the motor vehicle depicting types of storage containers that may be used with this system.

FIG. 5 is another cross-sectional view of the cross car bar in the recess.

FIG. 6 is a view of another type of storage container that may be used with this trunk space storage system.

### DETAILED DESCRIPTION OF THE PREFERRED EMBODIMENT

In its preferred embodiment, this trunk space storage system comprises at least one cross car bar 10, at least one recess 12, and at least one storage container 26. This trunk space storage system further comprises one front cross car bar 14, one back cross car bar 16, one front right recess 18, one left front recess 20, one right back recess 22, and one left back recess 24.

The one front right recess 18, one left front recess 20, one right back recess 22, and one left back recess 24 are located on the side walls of the motor vehicle as seen in the FIGS. Preferably, the one front right recess 18 and the one left front recess 20 are located in a position of equal height to each other and to the height of the one right back recess 22 and to the one left back recess 24 as seen in FIG. 1 and FIG. 4. In its preferred embodiment, the height desired for the one front right recess 18, one left front recess 20, one right back recess 22, and one left back recess 24 will depend on the storage container 26 a user desires for the trunk space storage system in their motor vehicle.

The front cross car bar 14 fits between the one front right recess 18 and one front left recess 20. The back cross car bar 16 fits between the one back right recess 22 and one back left recess 24. In its preferred embodiment, the front cross car bar 14 will be parallel to the back cross car bar 16 so as to provide the most stable trunk space storage system, as seen in FIG. 1, FIG. 4, and FIG. 6. At least one storage container 26 fits between the front cross car bar 14 and the back cross car bar 16.

This trunk space storage system allows for more then one storage container 26 if necessary. The storage container 26 may be made of a rigid or semi-rigid material or of a soft flexible material. The storage container 26 may have a lid as an added security feature. The storage container may also be foldable for easy storage within the trunk space when the user does not need this trunk space storage system. Also, the storage container may be removable for easy transport outside of the motor vehicle. This feature for use outside of the motor vehicle is desirable because a user will not have to unpack/pack up the trunk space every time they need access to objects in the trunk space.

In addition to the storage container 26 being able to be stowed when it is not in use, the front cross car bar 14 and back cross car bar 16 can also be stowed as seen in FIG. 3. Both cross car bars 14, 16 are removable so that a user has full access to the trunk space. The cross car bars 14, 16 can be shortened and stowed when the trunk space storage system is not needed.

The above presents a description of the best mode contemplated for carrying out this invention. The claims should not be read as limited to the described order or elements unless stated to that effect. Therefore, all embodiments that come with the scope and spirit of the following claims and equivalents thereto are claimed as the invention.

1. A trunk space storage system comprising:
at least one cross car bar adapted for extending across the trunk space;
at least one recess adapted to be located at a side of the trunk space, said cross car bar supported by said recess; and
at least one storage container supported by said cross car bar.

2. The trunk space storage system as in claim 1, comprising a pair of recesses wherein each of said pair of recesses is located on opposite side walls of the trunk space and support opposite ends of said cross car bar.

3. The trunk space storage system as in claim 1 comprising a pair of front recesses, a pair of back recesses, a front cross car bar, and a back cross car bar, wherein each of said pair of front recesses supports opposite ends of said front cross car bar and each of said pair of back recesses supports opposite ends of said back cross car bar, and wherein said storage container is supported by both of said front cross car bar and said back cross car bar.

4. The trunk space storage system as in claim 1, wherein said storage container fits over said cross car bar so as to be supported by said cross car bar.

5. The trunk space storage system as in claim 1, wherein said storage container is removably supported by said cross car bar.

6. The trunk space storage system as in claim 1, wherein said cross car bar is removably supported by said recess.

7. The trunk space storage system as set forth in claim 1, wherein the length of said cross car bar can be adjusted.
